(19) United States
(12) Patent Application Publication
(10) Pub. No.: US 2024/0185561 A1
(43) Pub. Date: Jun. 6, 2024

(54) AERIAL IMAGE CHANGE DETECTION APPARATUS

(71) Applicant: SKY Perfect JSAT Corporation, Tokyo (JP)

(72) Inventors: Yasuharu Sugawara, Tokyo (JP); Shinji Shimasaki, Tokyo (JP)

(21) Appl. No.: 18/381,389

(22) Filed: Oct. 18, 2023

(30) Foreign Application Priority Data
Oct. 20, 2022 (JP) 2022-168401

(51) Int. Cl. G06V 10/75; G06T 5/50; G06V 10/60; G06V 20/17

(52) U.S. Cl. CPC G06V 10/751; G06T 5/50; G06V 10/60; G06V 20/17; G06T 2207/20221

(57) ABSTRACT

An aerial image change detection apparatus: acquires N-number of first aerial images and M-number of second aerial images; obtains, with respect to a plurality of image pairs among N×M-number of image pairs of the first aerial images and the second aerial images, a change index for each pixel that represents a change in a pixel value between one first aerial image and one second aerial image; adopts a pixel of which the change index is larger than a change threshold as a change location candidate, wherein the change threshold is chosen in accordance with the pair of the first aerial image and the second aerial image; and determines, as a change location, a pixel considered to be a change location candidate in a prescribed percentage or more of the plurality of pairs.

### CROSS-REFERENCE TO RELATED APPLICATION

This application claims the benefit of Japanese Patent Application No. 2022-168401, filed on Oct. 20, 2022, which is hereby incorporated by reference herein in its entirety.

### BACKGROUND

### Field of the Invention

The present invention relates to a technique for detecting a change in aerial images.

### Description of the Related Art

There is a desire to detect a change of a large area (for example, the entire area of Japan) between two time periods from aerial images such as a satellite image. The change that is desirably detected is an actual change to a structure or the like such as appearance or disappearance of a building or a road, while a change due to an atmospheric phenomenon or solar irradiation is desirably not detected.

Japanese Patent Application Laid-open No. 2018-97506 proposes using an image recognition method that utilizes deep learning in order to detect a specific object from a satellite image with high precision or to prevent a change in brightness value due to a seasonal change of a same ground object from being recognized as a change.

Applying the method according to Japanese Patent Application Laid-open No. 2018-97506 to a large area, however, requires time, labor, and cost, since collecting and creating teaching data is difficult and learning is time-consuming. A change detection algorithm which does not need teaching data is therefore desired.

It is also desired for a change detection algorithm to be independent of location or region since adjusting a parameter for each location or region is difficult.

### SUMMARY

As described above, conventional techniques are unable to readily detect a change in aerial images.

In consideration thereof, an objective of the present disclosure is to provide a technique that enables a change in aerial images to be detected more easily than before.

A first aspect of the present disclosure is an aerial image change detection apparatus including: an image acquiring unit which acquires N-number of first aerial images and M-number of second aerial images, wherein the first aerial images are aerial images of a same area in a first period, the second aerial images are aerial images of the same area as the first aerial images in a second period subsequent to the first period, and N and M are both integers larger than or equal to 1; a change candidate extracting unit which obtains, with respect to a plurality of image pairs among N×M-number of image pairs of the first aerial images and the second aerial images, a change index for each pixel that represents a change in a pixel value between one first aerial image and one second aerial image and which adopts a pixel of which the change index is larger than a change threshold as a change location candidate, wherein the change threshold is chosen in accordance with the pair of the first aerial image and the second aerial image; and a change location extracting unit which determines, as a change location, a pixel considered to be a change location candidate in a prescribed percentage or more of the plurality of image pairs.

In the present aspect, the change index of a pixel may be a value in accordance with a ratio of a change in a pixel value of the pixel to a mean of changes in pixel values in a peripheral region of the pixel. When an aerial image has a plurality of bands such as RGB, a change in a pixel value may be a value based on a difference in pixel values of the respective bands (such as a sum of squared differences of pixel values over all bands or a sum of absolute differences of pixel values over all bands). In addition, a change in a pixel value may be a pixel value difference calculated for each pixel or a value obtained by subjecting the differences to filter processing for denoising. Furthermore, a mean of changes in pixel values in a peripheral region of the pixel may be obtained by subjecting pixel value differences calculated for each pixel to a smoothing filter (simple mean or weighted mean) with a relatively large kernel size. Establishing a change index in this manner enables a location captured brightly and a location captured darkly to be evaluated as similar changes and a change can be detected appropriately.

In the present aspect, the change candidate extracting unit may obtain the change index after adjusting at least one of the first aerial image and the second aerial image so that a mean value and a variance of pixel values of the first aerial image and the second aerial image are consistent. When an aerial image has a plurality of bands such as RGB, an adjustment may be performed per band or an entire image may be adjusted so that a mean and a variance of lightness are consistent. Performing adjustments in this manner enables the first aerial image and the second aerial image to be appropriately compared with each other.

In the present aspect, the change threshold may be set for each pair as a greater value among a prescribed value and a value corresponding to a higher first prescribed percentage of change indices calculated from the first aerial image and the second aerial image. By setting a threshold in this manner, while a pixel of which a change in a pixel value is larger than a prescribed value multiple of a mean change of a peripheral region is generally extracted as a change location candidate, the number of pixels extracted as a change location candidate can be kept within the first prescribed percentage of the total number of pixels in an entire aerial image. Limiting the number of pixels selected as a change location candidate in this manner enables false detection to be suppressed.

In the present aspect, the change candidate extracting unit may adopt a pixel as a change location candidate regardless of a value of the change index when a change of a pixel value of the pixel is larger than a prescribed value. When there is a change in a relatively large range, a change index (a ratio of a change in a pixel value to a mean change in a peripheral region) of a pixel may decrease and the pixel may be excluded from change location candidates. Separately extracting a pixel of which a change in a pixel value is large and adopting the extracted pixel as a change location candidate enables omissions of detection to be suppressed.

In the present aspect, the change candidate extracting unit may extract a pixel in an area obtained by performing area opening processing with respect to a change location candidate as a final change location candidate in the pair of the first aerial image and the second aerial image. Since a pixel with a small change area is likely to be a false detection, removing such pixels from change location candidates by performing area opening processing enables false detection to be suppressed.

In the present aspect, the change candidate extracting unit may obtain a shadow area in the pair of the first aerial image and the second aerial image and the shadow area may be excluded from the change location candidates.

In the present aspect, the change candidate extracting unit may obtain a dark area of which a pixel value in both the first aerial image and the second aerial image is smaller than or equal to a first threshold and obtain a sum area of a first area created by expanding the dark area in the first aerial image to a range in which a pixel value is smaller than or equal to a second threshold that is larger than the first threshold and a second area created by expanding the dark area in the second aerial image to a range in which a pixel value is smaller than or equal to the second threshold. The pixel value in this case can be, for example, lightness. According to the present method, an area that constitutes a shadow in at least either of a first aerial image and a second aerial image can be appropriately extracted.

In the present aspect, the image acquiring unit may acquire a partial area of a first large-area aerial image in the first period as the first aerial image and acquire a partial area of a second large-area aerial image in the second period as the second aerial image, wherein the partial areas are a same area on the ground. A photographed aerial image may be expected to capture a larger area than the first aerial image and the second aerial image. In such a case, a partial area may be acquired from a large-area aerial image. Note that a first large-area aerial image and a second large-area aerial image may correspond to different photographic areas as long as areas of the first aerial image and the second aerial image are included.

In the present aspect, the image acquiring unit may acquire the N-number of the first aerial images from a top N-number of the first large-area aerial images with a small cloud coverage in the partial area among more than N-number of first large-area aerial images and acquire the M-number of the second aerial images from a top M-number of the second large-area aerial images with a small cloud coverage in the partial area among more than M-number of second large-area aerial images. Selecting a first aerial image and a second aerial image in this manner enables a high-quality image to be acquired.

In the present aspect, a change location may be detected for each of a plurality of divided areas obtained by dividing an area of interest, and a change in the area of interest between the first period and the second period may be obtained. Since dividing an area of interest enables a high-quality image to be selected for each location and the inside of a divided area is likely to be a same land cover, a change detection can be performed with high accuracy.

In the present aspect, the aerial image change detection apparatus may further include an output unit which outputs, in superposition, at least any of the N-number of first aerial images and the M-number of second aerial images and the change location. Outputting a change location and an aerial image in superposition enables a location at which a change has occurred to be shown in an easily understandable manner.

A second aspect of the present disclosure is an aerial image change detection method including the steps of: acquiring N-number of first aerial images and M-number of second aerial images, wherein the first aerial images are aerial images in a first period, the second aerial images are aerial images of a same area as the first aerial images in a second period subsequent to the first period, and N and M are both integers or larger than or equal to 1; obtaining, with respect to a plurality of image pairs among N×M-number of image pairs of the first aerial images and the second aerial images, a change index for each pixel that represents a change in a pixel value between one first aerial image and one second aerial image and adopting a pixel of which the change index is larger than a change threshold as a change location candidate; and determining, as a change location, a pixel considered to be a change location candidate in a prescribed percentage or more of the plurality of image pairs.

A third aspect of the present disclosure is a program for causing a computer to execute the steps of: acquiring N-number of first aerial images being aerial images of a same area in a first period and M-number of second aerial images being aerial images of the same area as the first aerial images in a second period subsequent to the first period (where N and M are both integers equal to or larger than 1); obtaining, with respect to a plurality of image pairs among N×M-number of image pairs of the first aerial images and the second aerial images, a change index for each pixel that represents a change in a pixel value between one first aerial image and one second aerial image and adopting a pixel of which the change index is larger than a change threshold in accordance with the pair of the first aerial image and the second aerial image as a change location candidate; and determining, as a change location, a pixel considered to be a change location candidate in a prescribed percentage or more of the plurality of image pairs.

According to the present disclosure, a change in aerial images can be detected more easily than before.

### BRIEF DESCRIPTION OF THE DRAWINGS

FIG. 1 is a functional configuration diagram of a satellite image change detection apparatus according to an embodiment;

FIG. 2 is a hardware configuration diagram of the satellite image change detection apparatus according to the embodiment;

FIG. 3 is a flow chart showing change detection processing according to the embodiment;

FIG. 4 is a diagram explaining an area of interest and divided areas thereof;

FIG. 5 is a diagram explaining an outline of processing L1 shown in FIG. 3;

FIG. 6 is a flow chart showing details of change location candidate extraction processing S13 shown in FIG. 3;

FIG. 7 is a flow chart showing details of shadow area extraction processing S25 shown in FIG. 6; and

FIG. 8 is a diagram explaining the shadow area extraction processing S25 shown in FIG. 6.

### DESCRIPTION OF THE EMBODIMENTS

### Reference Method and Problems Thereof

First, a simple method of change detection in aerial images and problems of the method will be described.

Two aerial images from which a change is to be detected will be respectively denoted by Img1 and Img2. A simplest method of obtaining a change location is a method of obtaining a change index Diff of Img1 and Img2 for each pixel and assuming that the pixel is a change location if the change index Diff of the pixel is larger than or equal to a threshold. As the change index Diff, for example, a sum of squared differences of pixel values over RGB bands is conceivable.

Such a simple method has the following problems.

A first problem is that since a distribution of the change index Diff changes depending on location, time period, atmospheric conditions, and the like, change detection using a same threshold does not enable highly accurate detection. Although the threshold must be changed depending on the location or the like, adjusting the threshold takes time and effort.

A second problem is that changes which can be detected differ between a bright location and a dark location. At a bright location, since a pixel value is large, the change index Diff is large even if an actual change is small and, conversely, at a dark location, since a pixel value is small, the change index Diff is small even if an actual change is large. In this manner, a change is more readily detected from a location captured brightly and a change is less readily detected from a location captured darkly.

A third problem is that change detection is affected by a difference in appearance of a ground object or a difference in shadow. The appearance of a ground object or shadow changes depending on a period or a time of day of photography, and the difference in appearance of a ground object or shadow is detected as a change even when there is no actual change to the ground object.

### Proposed Method

Hereinafter, an aerial image change detection method according to an embodiment of the present disclosure will be described. While a satellite image will be used as an aerial image in the present embodiment, the present embodiment is similarly applicable to aerial images photographed by means other than a satellite.

Configuration

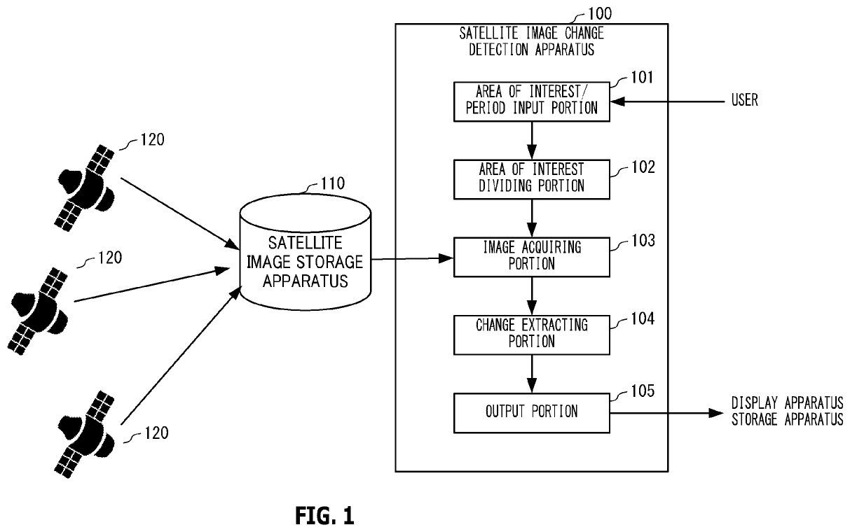

FIG. 1 is a block diagram explaining a functional configuration of a satellite image change detection apparatus 100 (hereinafter, also simply referred to as a change detection apparatus 100 or apparatus 100) according to the present embodiment. The change detection apparatus 100 is an apparatus for acquiring a satellite image of a first period and a satellite image of a second period (a period later than the first period) which capture an area of interest (AOI) and detecting a change location in the satellite images. The satellite images are photographed by a plurality of satellites 120 and are stored in a satellite image storage apparatus 110, and the change detection apparatus 100 acquires the satellite images from the satellite image storage apparatus 110.

FIG. 1 is a diagram showing a functional configuration of the change detection apparatus 100. As shown in FIG. 1, the change detection apparatus 100 includes, as functional units, an area of interest/period input portion 101, an area of interest dividing portion 102, an image acquiring portion 103, a change extracting portion 104, and an output portion 105.

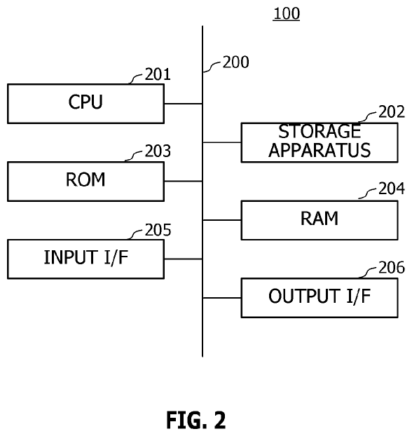

FIG. 2 is a diagram showing a hardware configuration of the change detection apparatus 100. As shown in FIG. 2, the change detection apparatus 100 includes a CPU 201, a storage apparatus 202, a ROM 203, a RAM 204, an input I/F 205, and an output I/F 206 which are respectively connected to a bus 200. The CPU 201 integrally controls each device connected via the bus 200. The CPU 201 reads and executes processing steps and programs stored in the ROM 203 or the RAM 204. The storage apparatus 202 is for storing various programs and data related to the present embodiment. The ROM 203 stores an operating system (OS), device drivers, and boot programs. The RAM 204 temporarily stores programs and data loaded from the storage apparatus 202 and the ROM 203 and has a work area used by the CPU 201 to appropriately execute each processing step. The input I/F 205 inputs a signal from an external apparatus as an input signal in a format that is processible by the change detection apparatus 100. The output I/F 206 outputs a signal to an external apparatus as an output signal in a format that is processible by the external apparatus. The change detection apparatus 100 realizes the functions shown in FIG. 1 by having the CPU 201 read and execute a program.

Processing

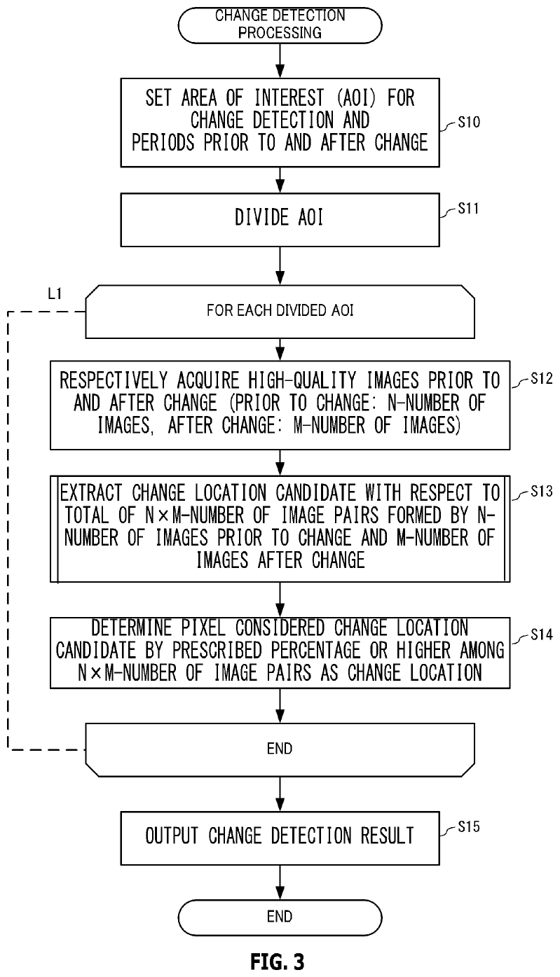

FIG. 3 is a flow chart showing a flow of change detection processing executed by the change detection apparatus 100. Hereinafter, the change detection processing according to the present embodiment will be described with reference to FIG. 3.

In step S10, the area of interest/period input portion 101 accepts a range of an area of interest that is an area over which change detection is to be performed, a period prior to a change (first period), and a period after the change (second period) from a user and sets the area of interest and the periods. While the area of interest may be any kind of range, for example, a large area such as an entire area of Japan may be assumed. In addition, the period prior to the change may be from Jul. 1, 2022, to Jul. 31, 2022 and the period after the change may be from Aug. 1, 2022 to Aug. 31, 2022. While lengths of the periods are set to one month and the periods prior to and after the change are consecutive periods, periods need not be arranged in this manner. For example, the period prior to the change and the period after the change may be shorter or longer and the lengths of the periods may differ from one another. In addition, the period prior to the change and the period after the change need not be consecutive periods.

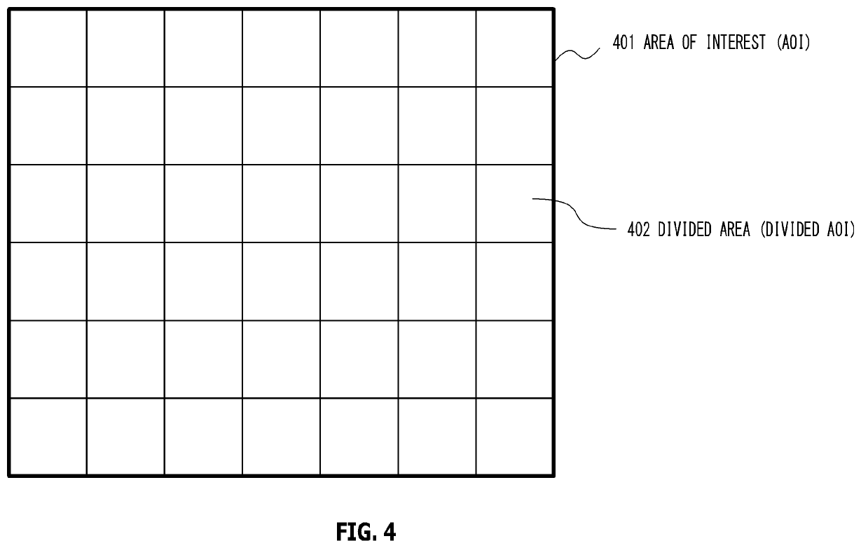

In step S11, the area of interest dividing portion 102 divides the input area of interest into small areas. FIG. 4 is a diagram explaining division of an area of interest. In FIG. 4, reference numeral 401 denotes an area of interest (AOI) and reference numeral 402 denotes a divided area (divided AOI) created by dividing the area of interest 401. The divided area 402 has an area size determined in advance and, as an example, the divided area 402 can be a square, about 1 km to 2 km on a side. The size of the divided area 402 is not particularly limited and the shape need not be a square and may be a rectangle or another polygon (for example, a triangle or a hexagon). While the area of interest 401 is divided into 7×6-number of divided areas 402 in FIG. 4, the area of interest 401 may be divided into a larger number of divided areas 402.

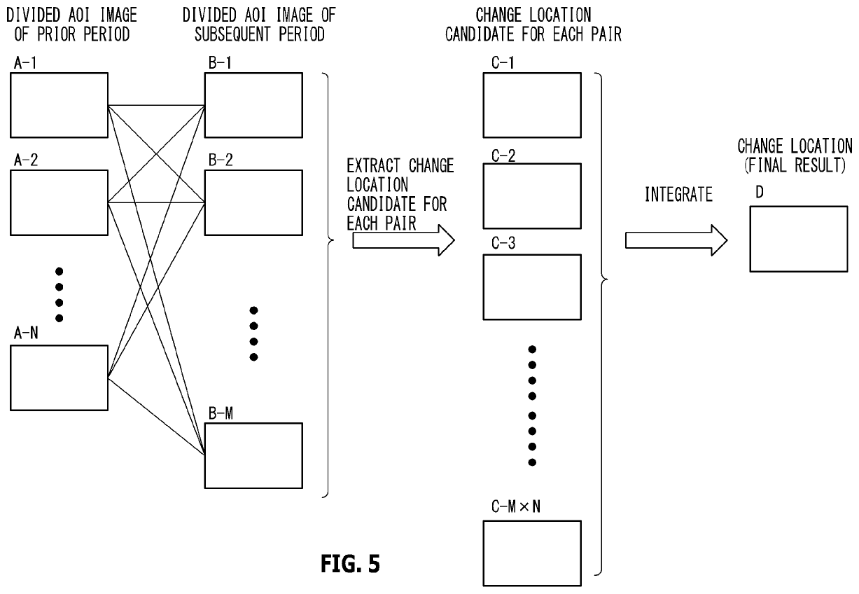

Change detection is performed in processing L1 of steps S12 to S14 for each divided area. The processing L1 of steps S12 to S14 may be either executed in parallel or executed in series for each divided area. FIG. 5 is a diagram explaining an outline of processing of one execution in the processing L1. First, in step S12, N-number of satellite images of divided areas in a period prior to change and M-number of satellite images of divided areas in a period after the change are acquired. Next, in step S13, a change location candidate is extracted with respect to each combination of N×M-number of image pairs formed by the N-number of satellite images prior to change and the M-number of satellite images after the change. Accordingly, N×M-number of images representing change location candidates are obtained for each divided area. Finally, in step S14, the N×M-number of change location candidates are integrated to determine a final change location. Since the processing L1 is performed for each divided area, consequently, a change location in the entire area of interest can be detected.

Hereinafter, the processing of steps S12 to S14 will be described in detail. Note that a divided area to be processed in the processing L1 may also be referred to as a target divided area in the following description.

In step S12, the image acquiring portion 103 acquires a satellite image of a target divided area from the satellite image storage apparatus 110. More specifically, the image acquiring portion 103 acquires N-number of satellite images of target divided areas in a period prior to change and M-number of satellite images of object divided areas in a period after the change. In this case, N and M are both integers larger than or equal to 1 and may satisfy any of N>M, N=M, and N<M. While an example of N and M is N=M=3, N and M may be larger numbers. The image acquiring portion 103 which executes the processing of step S12 corresponds to the image acquiring unit according to the present disclosure.

The satellite image storage apparatus 110 stores a larger number than N or M of satellite images of both the period prior to a change and the period after the change. The image acquiring portion 103 therefore selects and acquires satellite images with higher quality. Each of the satellite images stored in the satellite image storage apparatus 110 is, for example, a 20 km by 30 km image (in the case of Dove satellites of Planet Labs PBC). When scene classification data per pixel in a satellite image can be utilized, the image acquiring portion 103 may determine that the lower a cloud coverage of the image in a target divided area, the higher the quality, and may acquire a top N-number or a top M-number of images with lowest cloud coverage. In addition, when scene classification data per pixel cannot be utilized or when desiring to reduce processing time, the image acquiring portion 103 may determine that the lower a cloud coverage in the entire satellite image, the higher the quality. Note that the image acquiring portion 103 may determine quality in consideration of elements other than the cloud coverage and, for example, the image acquiring portion 103 may determine that quality is high when contrast is high or determine that quality is high with respect to an earlier period or a later period among a designated period.

The N-number of images of the target divided area in the period prior to a change acquired in step S12 correspond to the first aerial images according to the present disclosure and the M-number of images of the object divided area in the period after the change acquired in step S12 correspond to the second aerial images according to the present disclosure. In addition, hereinafter, an image of the target divided area in the period prior to a change (first period) will be referred to as a prior image and an image of the target divided area in the period after the change (second period) will be referred to as a subsequent image.

Next, in step S13, the change extracting portion 104 extracts a change location candidate with respect to each of N×M-number of image pairs formed by the N-number of prior images and the M-number of subsequent images. The change extracting portion 104 which executes the processing of step S13 corresponds to the change candidate extracting unit according to the present disclosure.

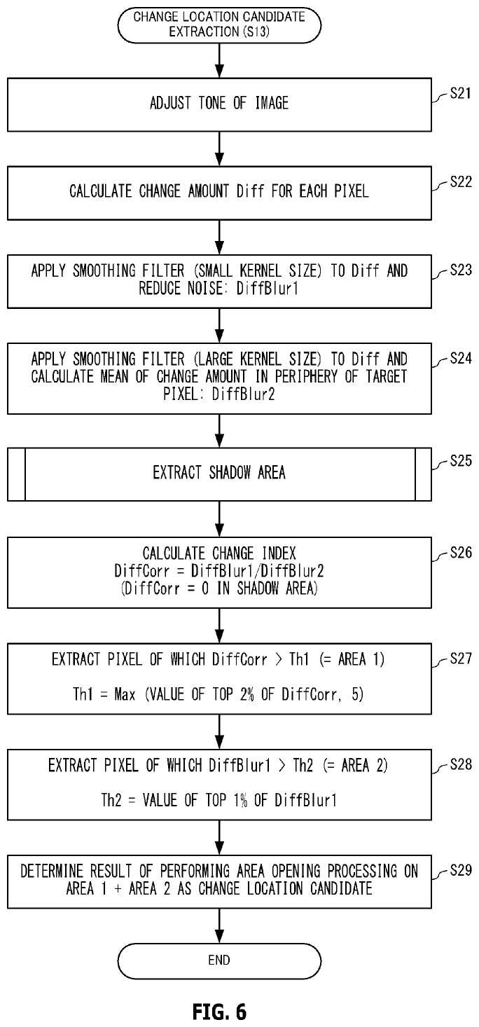

FIG. 6 is a flow chart showing details of change location candidate extraction processing in step S13. Note that the processing shown in FIG. 6 is described as processing performed for a given image pair.

In step S21, the change extracting portion 104 adjusts a tone of either or both of the prior image and the subsequent image. Specifically, at least one of the prior image and the subsequent image is adjusted so that a mean and a variance of pixel values of the prior image and the subsequent image are consistent. While an example of adjusting the prior image so as to conform to the subsequent image will be described, the subsequent image may be adjusted so as to conform to the prior image or both the prior image and the subsequent image may be adjusted so as to have a prescribed mean and variance. In the present embodiment, the change extracting portion 104 adjusts a pixel value of each band of RGB of the prior image as follows.

$$Img 1 [ c , i , j ] \to ( Img 1 [ c , i , j ] - Img {1 [ c ]}_{mean} ) \times \frac{Img {2 [ c ]}_{std}}{Img {1 [ c ]}_{std}} + Img {2 [ c ]}_{mean}$$

Imgₖ[c,i,j] (k=1,2) represents a pixel value of a band c of a pixel (i,j) in a prior image (k=1) or a subsequent image (k=2). Imgₖ[c]ₘₑₐₙ represents a mean of pixel values in the band c in the entire prior image (k=1) or the entire subsequent image (k=2) and Imgₖ[c]_{std} represents a standard deviation of pixel values in the band c in the entire prior image (k=1) or the entire subsequent image (k=2).

In step S22, the change extracting portion 104 calculates a change amount Diff for each pixel with respect to the prior image and the subsequent image after adjustment. In the present embodiment, a sum of squares of a difference in respective band values is adopted as the change amount Diff as represented by the expression below.

$$Diff [ i , j ] = {\sum }_{c = r , g , b} {( Img 1 [ c , i , j ] - Img 2 [ c , i , j ] )}^{2}$$

Note that the change amount Diff may be a sum of absolute values of a difference or the like instead of a sum of squares of the difference.

In step S23, in order to reduce noise in the change amount Diff, the change extracting portion 104 applies a smoothing filter with a small kernel size to the change amount Diff. The change amount after applying the filter will be referred to as DiffBlur1. In the present embodiment, a Gaussian filter with a kernel size of 5×5 is applied as will be described below. Obviously, the kernel size is not limited to this size and a smoothing filter other than a Gaussian filter such as a box filter (simple mean) or a bilateral filter may be adopted. The following image processing will be described based on OpenCV2.

DiffBlur1=cv2·GaussianBlur(Diff,(5,5),0)

Note that 0 of a third parameter means that a standard deviation value of a Gaussian kernel is to be set to a default value in accordance with a kernel size. In step S24, in order to calculate a (weighted) mean of changes in a peripheral region of each pixel, the change extracting portion 104 applies a smoothing filter with a large kernel size to the change amount Diff. The change amount after applying the filter will be referred to as DiffBlur2. In the present embodiment, a Gaussian filter with a kernel size of 151×151 is applied as will be described below. Obviously, the kernel size is not limited to this size and a smoothing filter other than a Gaussian filter such as a box filter (simple mean) or a bilateral filter may be adopted.

DiffBlur2=cv2·GaussianBlur(Diff,(151,151),0)

In step S25, the change extracting portion 104 extracts a shadow area in the image pair formed by the prior image and the subsequent image. Shadow area extraction processing will be described later.

In step S26, the change extracting portion 104 calculates a change index DiffCorr for each pixel representing a change in a pixel value of the prior image and the subsequent image as a ratio of a change in a pixel value of a pixel to a mean of changes in pixel values in a peripheral region of the pixel as shown in the following expression. Note that an area obtained as a shadow area in step S25 is assumed to be DiffCorr=0 (no change).

$$DiffCorr = \frac{DiffBlur 1}{DiffBlur 2} \qquad ( Other than shadow area )$$

$$DiffCorr = 0 \qquad ( Shadow area )$$

By adopting a ratio of a change in a target pixel to a mean change in a peripheral region of the target pixel as a change index, a change in a location captured darkly can be detected as readily as in a location captured brightly. In addition, by setting the change index of a shadow area to 0, the shadow area can be prevented from being detected as a change.

In step S27, the change extracting portion 104 extracts a first change candidate based on the change index DiffCorr. As shown in the following expression, the first change candidate is extracted as a pixel having a change index DiffCorr that is larger than a threshold Th1.

DiffCorr[i,j]>Th1=max(A,Value corresponding to top p% of DiffCorr)

In this case, the threshold Th1 is defined as whichever value is greater between a prescribed value A and a value corresponding to a top p % (first prescribed percentage) in the change index DiffCorr. A determination of such a threshold Th1 signifies the following. While the change extracting portion 104 adopts a pixel of which the change index DiffCorr is greater than the prescribed value A as a change location candidate, an upper limit of the number of the candidates is set to p % of a divided area. Under the assumption that there is no large-scale change in the divided area, limiting the number of the change location candidates in this manner leads to reduction of false detection.

As the prescribed value A, for example, A=5 can be adopted. This means that, in a target pixel, if there is change that is five times or more of a mean change in a peripheral region, the target pixel is considered as a change location candidate. In addition, the first prescribed percentage p can be set to, for example, p=2%.

In step S28, the change extracting portion 104 extracts a second change candidate based on a change index DiffBlur1. The second change candidate is extracted as a location of which the change amount DiffBlur1 of a pixel value is greater than a prescribed value Th2 as shown in the following expression. The prescribed value Th2 is a value corresponding to a top q % in DiffBlur1. In this case, for example, q=1%. Note that q<p need not be satisfied and q≥p may suffice.

DiffBlur1[i,j]>Th2=Value corresponding to top q% in DiffBlur1

The second change candidate corresponds to a pixel of which the change amount DiffBlur1 is large. The second change candidate is adopted because, even if the change amount DiffBlur1 is large, a ratio (DiffCorr) to a periphery decreases when a range of change is large and a pixel is to be removed from first change candidates. In order to prevent such omissions in change detection, a pixel of which an original change amount (DiffBlur1) is relatively large is separately extracted as a second change candidate. Since the extraction is performed for such a reason, the threshold Th2 need not be a relative value such as a value corresponding to a top q % of DiffBlur1 and may be a fixed value or whichever value is greater between a relative value and a fixed value in a similar manner to the first change candidate.

In step S29, the change extracting portion 104 performs area opening processing on a sum area (first change candidate+second change candidate) of an area of the first change candidate obtained in step S27 and an area of the second change candidate obtained in step S28. The area opening processing is processing that involves expanding an area by a prescribed number of pixels and then contracting the area by the same number of pixels and enables small noises to be removed. Since a change to a ground object or terrain is expected to have a certain size and a change location with small size is likely to be a false detection, performing area opening processing is effective.

The change extracting portion 104 determines an area obtained after the area opening processing as a change location candidate in the image pair of the prior image and the subsequent image that are presently being handled.

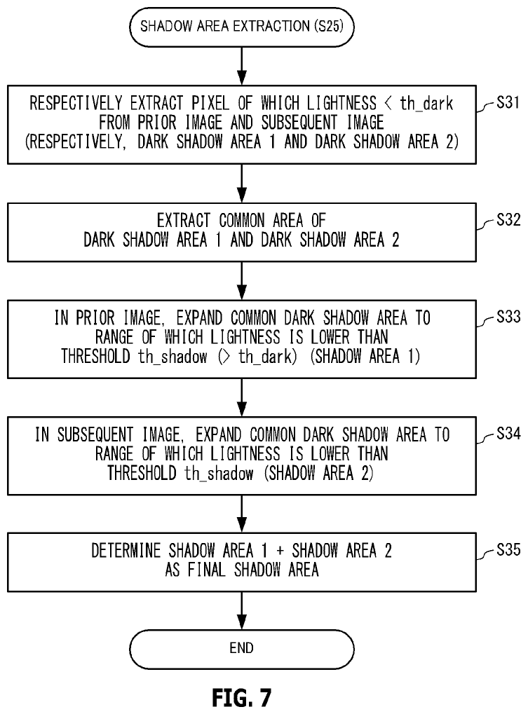

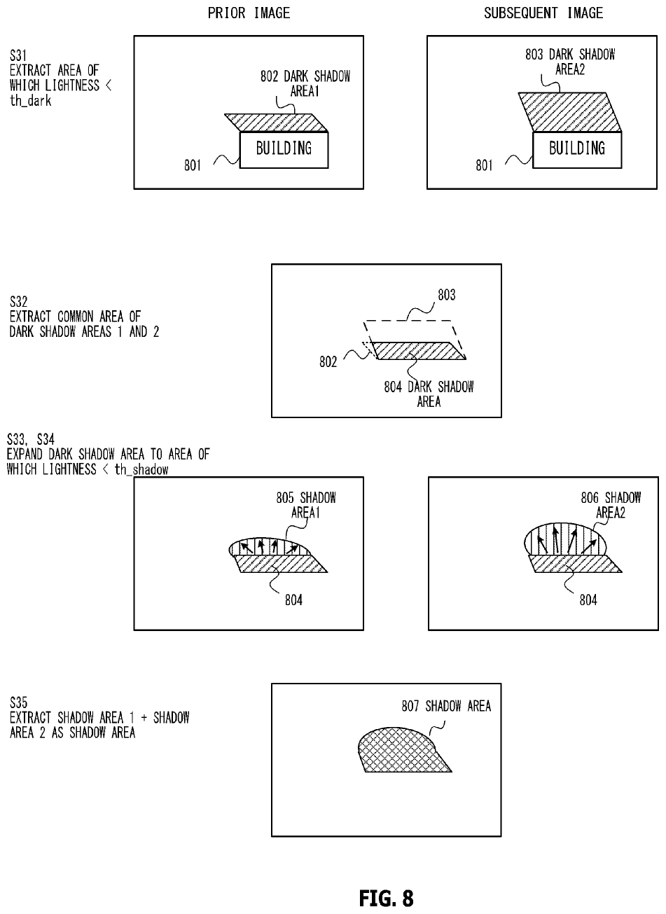

Extraction processing of a shadow area in step S25 (FIG. 6) will now be described. FIG. 7 is a detailed flow chart of shadow extraction processing in step S25 and FIG. 8 is a diagram for explaining shadow extraction processing. Hereinafter, shadow extraction processing will be described with reference to FIGS. 7 and 8. The change extracting portion 104 which executes step S25 corresponds to the shadow area extracting unit according to the present disclosure.

In step S31, the change extracting portion 104 extracts, from each of the prior image and the subsequent image, a pixel of which lightness is lower than a threshold th_dark. For example, th_dark=50 (maximum lightness 255). This is the processing of extracting an area with a dark shadow. Since solar elevation and seasons differ from one image to the next, shadows are different in the prior image and the subsequent image. As shown in FIG. 8, a first dark shadow area 802 and a second dark shadow area 803 that are respectively adjacent to a building 801 being captured in the prior image and the subsequent image are extracted.

In step S32, a common area of the first dark shadow area 802 and the second dark shadow area 803 is extracted as a dark shadow area 804. The dark shadow area 804 obtained in this manner is a location that is captured darkly both in the prior image and the subsequent image and is an area that is highly likely to be a shadow area.

In step S33, the change extracting portion 104 expands the dark shadow area 804 in the prior image to an area of which lightness is lower than th_shadow (>th_dark). For example, th_shadow=60. As a result, for example, a first shadow area 805 is obtained in the prior image.

In step S34, the change extracting portion 104 expands the dark shadow area 804 in the subsequent image to an area of which lightness is lower than th_shadow (>th_dark). As a result, for example, a second shadow area 806 is obtained in the subsequent image. In step S35, the change extracting portion 104 determines a sum area (the first shadow area 805+the second shadow area 806) of the first shadow area 805 and the second shadow area 806 as a shadow area 807 in the image pair formed by the prior image and the subsequent image.

In such processing, an area that is a shadow in either of the prior image and the subsequent image can be extracted. An objective in the present embodiment is to detect a change in a ground object or terrain and a change due to a shadow is desirably excluded. Setting the change index DiffCorr in a shadow area to 0 as described above prevents a shadow area from being detected as a change location candidate.

Since the goal of the processing is to exclude shadow areas from change locations, a change amount Diff of a shadow area may be set to 0 in step S22 or, after obtaining change location candidates without taking shadow areas into consideration, the shadow areas may be excluded from the change location candidates.

According to the processing of step S13 described above, change location candidates in the pair of the prior image and the subsequent image are obtained. While the description given above assumes a specific image pair, the processing in step S13 is to be performed with respect to all N×M-number of image pairs. In other words, the calculation of the change index DiffCorr and the extraction of change location candidates are to be performed for each image pair.

In step S14, the change extracting portion 104 determines a pixel determined to be a change location candidate by a prescribed percentage or higher among the N×M-number of image pairs of a divided area as a change location. As the prescribed percentage, for example, an appropriate value that meets requirements such as 100%, 90%, or 75% may be used. False detections decrease while omissions of detection increase when the value of the prescribed percentage increases. Conversely, false detections increase while omissions of detection decrease when the value of the prescribed percentage decreases. In order to suppress false detections, the prescribed percentage is preferably set to a relatively large value.

According to processing in steps S12 to S14 described above, detection of change locations with respect to a divided area is completed. By performing the processing L1 with respect to all divided areas, detection of change locations from an entire area of interest is completed.

In step S15, the output portion 105 outputs the detected change locations of the entire area of interest. A mode of output is not particularly limited and a change location and an image of the area of interest may be superimposed and output, the change location and the image of the area of interest may be separately output, or only the change location may be output as a polygon. When external information related to land cover can be utilized, land cover information may be added to the polygon and output so that the external information can also be displayed on a change location of specific land cover. An image obtained by compositing high-quality (small cloud coverage) divided images for each divided area results in an image of the entire area of interest with a small amount of clouds. The output portion 105 may output a detection result to a display apparatus to be displayed thereon or output the detection result to a storage apparatus to be stored therein.

### Advantageous Effects of Embodiment

The change detection method according to the present embodiment has the following advantages.

First, an area of interest is divided into a plurality of divided areas and a change is detected for each divided area. Therefore, an image with high quality can be selected with respect to each divided area and the inside of an image is likely to be same land cover. This characteristic is useful for solving the problems 1 and 2 according to the reference method described at the beginning of the present disclosure.

Second, when extracting a change location candidate in an image pair, by extracting up to a top p % of a change index DiffCorr in a divided area, the number of pixels of a change location candidate is held to p % or lower of the entire divided area. Extracting a location with a relatively large change index in each area as a change location candidate instead of using a fixed value as a threshold of the change index is substantially the same as setting an appropriate threshold in accordance with a divided area. The present method enables a suitable threshold to be readily obtained and is useful for solving the problems 1 and 2 according to the reference method.

Third, change detection is performed by using, as a change index, a ratio of a change amount Diff (or DiffBlur1 obtained by denoising Diff) of a pixel value to a mean change DiffBlur2 of a peripheral region instead of a value of the change amount Diff itself. Accordingly, a location captured brightly and a location captured darkly can be evaluated as similar changes and change detection can be performed in a suitable manner. This characteristic is useful for solving the problem 2 according to the reference method.

Fourth, due to shadow area extraction according to the present method, a shadow area can be obtained readily and with high precision. In addition, by excluding shadow areas from change locations, a change due to shadows depending on solar elevation and seasons can be excluded and only a change in a ground object or terrain can be captured. This characteristic is useful for solving the problem 3 according to the reference method.

Fifth, change location candidates are extracted with respect to all combinations of a plurality of prior images and a plurality of subsequent images and pixels determined to be change location candidates by a prescribed percentage or higher (or in all combinations) are extracted as change locations. In addition, high-quality images are acquired in plurality both before and after a change and change detection is performed with respect to all combinations. Accordingly, apparent changes attributable to shadows and appearances and changes due to cloud cover can be excluded and only actual changes in a ground object or terrain can be detected. This characteristic is useful for solving the problems 1 and 3 according to the reference method.

As described above, according to the present embodiment, high-quality change detection with minimal false detection can be readily performed with respect to a large area without having to endure the hassle of adjusting a threshold or parameter for each location or collecting learning data.

### MODIFICATIONS

While an embodiment of the present disclosure has been described above, the description given heretofore is not intended to limit the present disclosure. A technical scope of the present disclosure is to be determined based on the description of the scope of claims and modifications without departing from the technical scope disclosed in the present specification are also included in the present disclosure.

For example, while an example of a satellite image has been described above, change detection may be performed with respect to an aerial image photographed by a flight vehicle other than a satellite (a manned or an unmanned airplane, a balloon, an airship, or the like).

In addition, while a change location candidate is obtained with respect to all image pairs of aerial images in a first period and aerial images in a second period (step S13), not all image pairs need to be used and a change location candidate may be obtained with respect to a plurality of image pairs among all image pairs. In this case, in step S14, a pixel considered a change location candidate by a prescribed percentage or higher among all image pairs may be determined as a change location.

Furthermore, while a result (DiffBlur1) of applying a smoothing filter with a relatively small kernel size to the change amount Diff is used for each pixel in step S23, this procedure may be omitted since DiffBlur1 is used in order to reduce noise. In this case, Diff/DiffBlur2 may be used as the change index DiffCorr. In addition, a result of applying filter processing other than a smoothing filter to the change amount Diff may be used as DiffBlur1.

In addition, in steps S27 to S29, a first change candidate and a second change candidate are obtained and a sum area thereof is adopted as a change location candidate. However, only one of the first change candidate and the second change candidate may be used or a third change candidate obtained by a separate method may be taken into further consideration.

What is claimed is:

1. An aerial image change detection apparatus, comprising:
an image acquiring unit which acquires N-number of first aerial images and M-number of second aerial images, wherein the first aerial images are aerial images of a same area in a first period, the second aerial images are aerial images of the same area as the first aerial images in a second period subsequent to the first period, and N and M are both integers larger than or equal to 1;
a change candidate extracting unit which obtains, with respect to a plurality of image pairs among N×M-number of image pairs of the first aerial images and the second aerial images, a change index for each pixel that represents a change in a pixel value between one first aerial image and one second aerial image and which adopts a pixel of which the change index is larger than a change threshold as a change location candidate, wherein the change threshold is chosen in accordance with the pair of the first aerial image and the second aerial image; and
a change location extracting unit which determines, as a change location, a pixel considered to be a change location candidate in a prescribed percentage or more of the plurality of image pairs.

2. The aerial image change detection apparatus according to claim 1, wherein the change index of a pixel is a value in accordance with a ratio of a change in a pixel value of the pixel to a mean of changes in pixel values in a peripheral region of the pixel.

3. The aerial image change detection apparatus according to claim 1, wherein the change candidate extracting unit obtains the change index after adjusting at least one of the first aerial image and the second aerial image so that a mean value and a variance of pixel values of the first aerial image and the second aerial image are consistent.

4. The aerial image change detection apparatus according to claim 1, wherein the change threshold is set for each pair as a greater value among a prescribed value and a value corresponding to a higher first prescribed percentage of change indices calculated from the first aerial image and the second aerial image.

5. The aerial image change detection apparatus according to claim 1, wherein the change candidate extracting unit adopts a pixel as a change location candidate regardless of a value of the change index when a change of a pixel value of the pixel is larger than a prescribed value.

6. The aerial image change detection apparatus according to claim 1, wherein the change candidate extracting unit extracts a pixel obtained by performing area opening processing with respect to a change location candidate as a final change location candidate in the pair of the first aerial image and the second aerial image.

7. The aerial image change detection apparatus according to claim 1, wherein the change candidate extracting unit obtains a shadow area in the pair of the first aerial image and the second aerial image and the shadow area is excluded from the change location candidates.

8. The aerial image change detection apparatus according to claim 7, wherein the change candidate extracting unit obtains a dark area of which a pixel value in both the first aerial image and the second aerial image is smaller than or equal to a first threshold and obtains a sum area of a first area created by expanding the dark area in the first aerial image to a range in which a pixel value is smaller than or equal to a second threshold that is larger than the first threshold and a second area created by expanding the dark area in the second aerial image to a range in which a pixel value is smaller than or equal to the second threshold.

9. The aerial image change detection apparatus according to claim 1, wherein the image acquiring unit:
acquires a partial area of a first large-area aerial image in the first period as the first aerial image; and
acquires a partial area of a second large-area aerial image in the second period as the second aerial image.

10. The aerial image change detection apparatus according to claim 9, wherein the image acquiring unit:
acquires the N-number of the first aerial images from a top N-number of the first large-area aerial images with a small cloud coverage in the partial area among more than N-number of first large-area aerial images in the first period; and
acquires the M-number of the second aerial images from a top M-number of the second large-area aerial images with a small cloud coverage in the partial area among more than M-number of second large-area aerial images in the second period.

11. The aerial image change detection apparatus according to claim 9, wherein a change location is detected for each of a plurality of divided areas obtained by dividing an area of interest, and a change in the area of interest between the first period and the second period is obtained.

12. The aerial image change detection apparatus according to claim 1, further comprising an output unit which outputs, in superposition, at least any of the N-number of first aerial images and the M-number of second aerial images and the change locations.

13. An aerial image change detection method comprising the steps of:
acquiring N-number of first aerial images and M-number of second aerial images, wherein the first aerial images are aerial images of a same area in a first period, the second aerial images are aerial images of the same area as the first aerial images in a second period subsequent to the first period, and N and M are both integers larger than or equal to 1;
obtaining, with respect to a plurality of image pairs among N×M-number of image pairs of the first aerial images and the second aerial images, a change index for each pixel that represents a change in a pixel value between one first aerial image and one second aerial image and adopting a pixel of which the change index is larger than a change threshold as a change location candidate, wherein the change threshold is chosen in accordance with the pair of the first aerial image and the second aerial image; and
determining, as a change location, a pixel considered to be a change location candidate in a prescribed percentage or more of the plurality of image pairs.

14. A computer-readable medium non-transitorily storing a program for causing a computer to execute the steps of:
acquiring N-number of first aerial images and M-number of second aerial images, wherein the first aerial images are aerial images in a first period, the second aerial images are aerial images of a same area as the first aerial images in a second period subsequent to the first period, and N and M are both integers larger than or equal to 1;
obtaining for each pixel, with respect to a plurality of image pairs among N×M-number of image pairs of the first aerial images and the second aerial images, a change index that represents a change in a pixel value between one first aerial image and one second aerial image and adopting a pixel of which the change index is larger than a change threshold as a change location candidate, wherein the change threshold is chosen in accordance with the pair of the first aerial image and the second aerial image; and
determining, as a change location, a pixel considered to be a change location candidate in a prescribed percentage or more of the plurality of pairs.
